(19) United States
(12) Patent Application Publication
(10) Pub. No.: US 2017/0008677 A1
(43) Pub. Date: Jan. 12, 2017

(54) Snap-Over Spout Fitment and Manufacture Methods

(71) Applicant: Plastek Industries, Inc., Erie, PA (US)

(72) Inventors: Timothy C. Dzurik, Erie, PA (US); Alex S. Szekely, Jackson, NJ (US); Peter A. Piscopo, Medford, NJ (US)

(73) Assignee: Plastek Industries, Inc., Erie, PA (US)

(21) Appl. No.: 15/206,829

(22) Filed: Jul. 11, 2016

Related U.S. Application Data
(60) Provisional application No. 62/191,373, filed on Jul. 11, 2015.

(51) Int. Cl. B65D 47/06; B65D 41/26; B29C 45/00; B65D 23/10; B65D 1/02; B65D 41/04; B65D 25/42

(52) U.S. Cl. CPC B65D 47/06; B65D 41/04; B65D 41/26; B65D 25/42; B65D 23/10; B65D 1/023; B29C 45/0081; B29K 2023/12

(57) ABSTRACT

A spout fitment (24; 200; 300; 400) has: a spout (50); an outer wall (52); an intermediate wall (51) between the outer wall and the spout; a plurality of projections (90) extending from the outer wall; and a plurality of apertures (140) each aligned with a respective associated projection of the plurality of projections.

### CROSS-REFERENCE TO RELATED APPLICATION

Benefit is claimed of U.S. Patent Application No. 62/191,373, filed Jul. 11, 2015, and entitled “Snap-Over Spout Fitment and Manufacture Methods”, the disclosure of which is incorporated by reference herein in its entirety as if set forth at length.

### BACKGROUND OF THE INVENTION

The invention relates to containers. More particularly, the invention relates to pour spouts for containers for liquid laundry detergent and the like.

There has been an evolution in the configuration of containers for liquid laundry detergent, fabric softener, and the like. The dominant form of container is a wide mouth bottle having an attached spout with a drain-back trough and aperture (often identified as a drain back spout (DBS) configuration). In a typical group of container configurations and their methods of assembly, a bottle body, spout fitment, and cap are individually molded (e.g., of high density polyethylene (HDPE) for the body, polypropylene for the cap, and low density polypropylene (LDPE) for the spout fitment). Exemplary bottle body molding is via blow molding whereas exemplary spout fitment and cap molding are by injection molding. An exemplary spout fitment includes the spout and a continuation of the spout defining the base and outboard wall of the trough. The fitment further typically includes a flange (e.g., extending outward at an upper end of the outboard extremity of the outboard wall).

The spout fitment may be inserted through a mouth of the bottle body (e.g., so that an outer surface of the outboard trough wall, or another wall outboard thereof, engages the inner surface of the bottle neck). The spout fitment may be secured and sealed to the bottle body such as by spin welding. The bottle may be filled and the cap may be installed. Exemplary caps typically have either an externally threaded skirt for engaging an internally threaded portion of the fitment or an internally threaded skirt for engaging an externally threaded portion of the fitment or bottle body neck. With a typical externally threaded skirt, the cap includes an outwardly projecting flange above the skirt. Upon installation of the cap to the fitment, the flange underside contacts and seals with the fitment flange upper surface to seal the bottle.

Various examples of bottles are shown in U.S. Pat. Nos. 6,923,341, 5,941,422, 5,566,862, and 5,603,787. US Patent Publications 2010/0043910 and 2009/0101682 disclose particular examples of snap-in and snap-over spout fitments.

International Application PCT/US 13/68002 discloses additional bottle filling methods. International Application PCT/US 15/25892 discloses a snap-over spout fitment where the fitment includes retention fingers extending upward from an outer wall of the spout fitment. The fingers are molded in a downward condition and then inverted prior to snap-over installation. Once installed, upper ends of the fingers abut the underside of a flange of the bottle neck to retain the spout fitment to the bottle body.

### SUMMARY OF THE INVENTION

One aspect of the invention involves a spout fitment having: a spout; an outer wall; an intermediate wall between the outer wall and the spout; a plurality of projections extending from the outer wall; and a plurality of apertures each aligned with a respective associated projection of the plurality of projections.

A further embodiment may additionally and/or alternatively include there being seven to fifteen said apertures and an equal number of said projections.

A further embodiment may additionally include a container comprising a body having a neck extending to a mouth defining a body opening. The spout is within the body opening. The outer wall surrounds an upper portion of the neck. The plurality of projections are in backlocked engagement with one or more features of the neck. A cap has sidewall, an external thread of the cap sidewall engaged to an internal thread of the intermediate wall.

A further embodiment may additionally and/or alternatively include the plurality of projections extending mouthward from the outer wall.

A further embodiment may additionally and/or alternatively include a channel along an inner surface of the outer wall receiving a lug of the body to angularly register the spout fitment.

A further embodiment may additionally and/or alternatively include the one or more features being a single full annulus feature.

A further embodiment may additionally and/or alternatively include the one or more features being a protrusion from an outer surface of the neck having an associated recess in an inner surface of the neck.

A further embodiment may additionally and/or alternatively include the one or more projections having a proximally tapering thickness from a distal end to a root end.

A further embodiment may additionally and/or alternatively include the one or more projections being a plurality of projections in a circumferential array.

A further embodiment may additionally and/or alternatively include the plurality of projections having a plurality of alternatingly interspersed gaps.

A further embodiment may additionally and/or alternatively include means on the body and fitment for preventing relative rotation of the body and fitment about a central longitudinal axis of the opening.

A further embodiment may additionally and/or alternatively include the fitment comprising a trough between the intermediate wall and spout with at least one drain aperture.

A further embodiment may additionally and/or alternatively include the body consisting essentially of HDPE; the spout fitment consisting essentially of polypropylene; and the cap consisting essentially of polypropylene.

A further embodiment may additionally and/or alternatively include the body having an integrally molded handle; and an interior compartment of the body extends through the handle.

A further embodiment may additionally and/or alternatively include the fitment being neither adhered nor welded to the body.

A further embodiment may additionally and/or alternatively include the fitment being not threadingly engaged to the body.

A further embodiment may additionally and/or alternatively include a cap sealing surface being along an underside of a flange of the cap.

A further embodiment may additionally and/or alternatively include the cap sealing surface covering the apertures.

A further embodiment may additionally and/or alternatively include 1.0-6.0 liters of a liquid within the body.

A further embodiment may additionally and/or alternatively include at least 1.0 liter of liquid detergent or fabric softener within the body

A further embodiment may additionally and/or alternatively include the body being a blow molded body.

Another aspect of the disclosure involves a method for molding the spout fitment comprising injecting plastic into a mold. The mold has a first portion and a second portion. The mold first portion molds an upper portion of the respective projections and the mold second portion molding lower portions of the respective projections. The mold first portion is separated from the mold second portion. The mold first portion comprises a plurality of fingers that withdraw through the respective apertures.

A further embodiment may additionally and/or alternatively include: inserting the spout fitment into a neck portion of a container body, the inserting comprising a resilient deformation of the at least one projection followed by an at least partial relaxation so as to engage a locking surface of the at least one projection to a locking surface of the container body to resist a reverse extraction; and threading a cap onto at least one of the spout fitment and container body.

A further embodiment may additionally and/or alternatively include the threading being at least partially before the inserting.

A further embodiment may additionally and/or alternatively include the inserting consisting essentially of a linear insertion.

A further embodiment may additionally and/or alternatively include delivering at least 1.0 liter of a liquid into the container body.

A further embodiment may additionally and/or alternatively include the delivering being before the inserting.

A further embodiment may additionally and/or alternatively include there being no welding or adhesive bonding of the spout fitment to the container body before the delivering.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a side view of a bottle.

FIG. 2 is a top cutaway view of an upper portion of the bottle of FIG. 1.

FIG. 3 is an upward sectional view of the bottle taken along line 3-3 of FIG. 1.

FIG. 4 is a central vertical medial sectional view of the portion of FIG. 3, taken along line 4-4.

FIG. 5 is a central vertical transverse sectional view of the portion of FIG. 3, taken along line 5-5.

FIG. 5A is an enlarged view of a portion of the bottle portion of FIG. 5, taken along line 5A-5A.

FIG. 6 is an enlarged view of a portion of an alternate bottle taken similarly to FIG. 5A.

FIG. 7 is a top view of a spout fitment of the bottle of FIG. 1.

FIG. 8 is a bottom view of the spout fitment.

FIG. 8A is an enlarged view of a rear portion of the spout fitment taken along line 8A-8A of FIG. 8.

FIG. 9 is a front view of the spout fitment.

FIG. 10 is a central vertical medial sectional view of the spout fitment.

FIG. 10A is an enlarged view of a portion of the spout fitment taken along line 10A-10A of FIG. 10.

FIG. 11 is a view of the portion of FIG. 10 with mold portions shown in broken line.

FIG. 12 is a central vertical medial sectional view of a subassembly of the spout fitment and a cap.

FIG. 12A is an enlarged view of a portion of the subassembly taken along line 12A-12A of FIG. 12.

FIG. 13 is a central vertical medial sectional view of the spout fitment assembled to a bottle body.

FIG. 14 is a central vertical medial sectional view of the spout fitment assembled to the body of the alternate bottle of FIG. 6.

The drawings reflect artifacts of computer modeling such as showing interference as overlap (whereas actual hardware would experience deformation).

Like reference numbers and designations in the various drawings indicate like elements.

### DETAILED DESCRIPTION

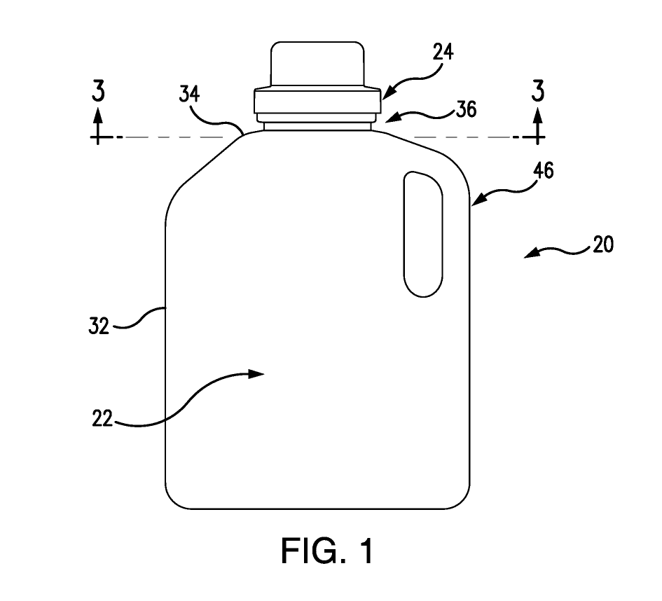

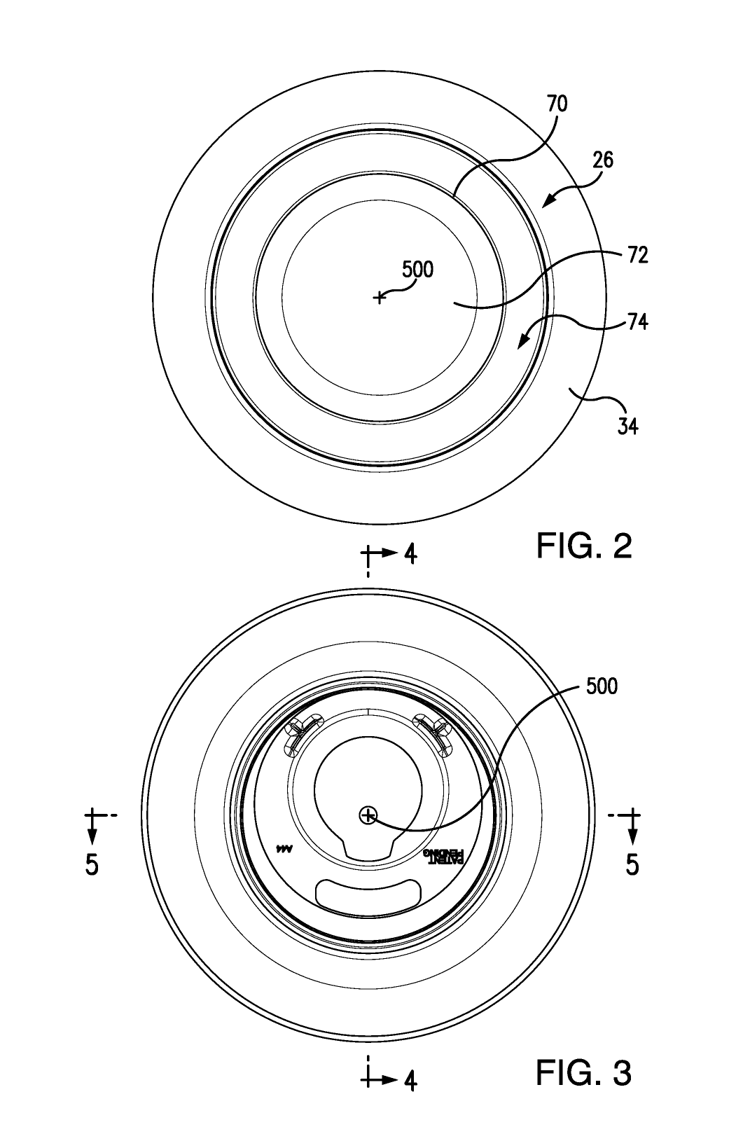

FIG. 1 shows a container 20 comprising the assembly of a bottle body 22, a spout fitment 24, and a cap 26 (which may serve as a measuring/dispensing cup). Each may be made as a unitary plastic molding. Exemplary bottle body material is high density polyethylene (HDPE). Exemplary spout fitment and cap material is polypropylene.

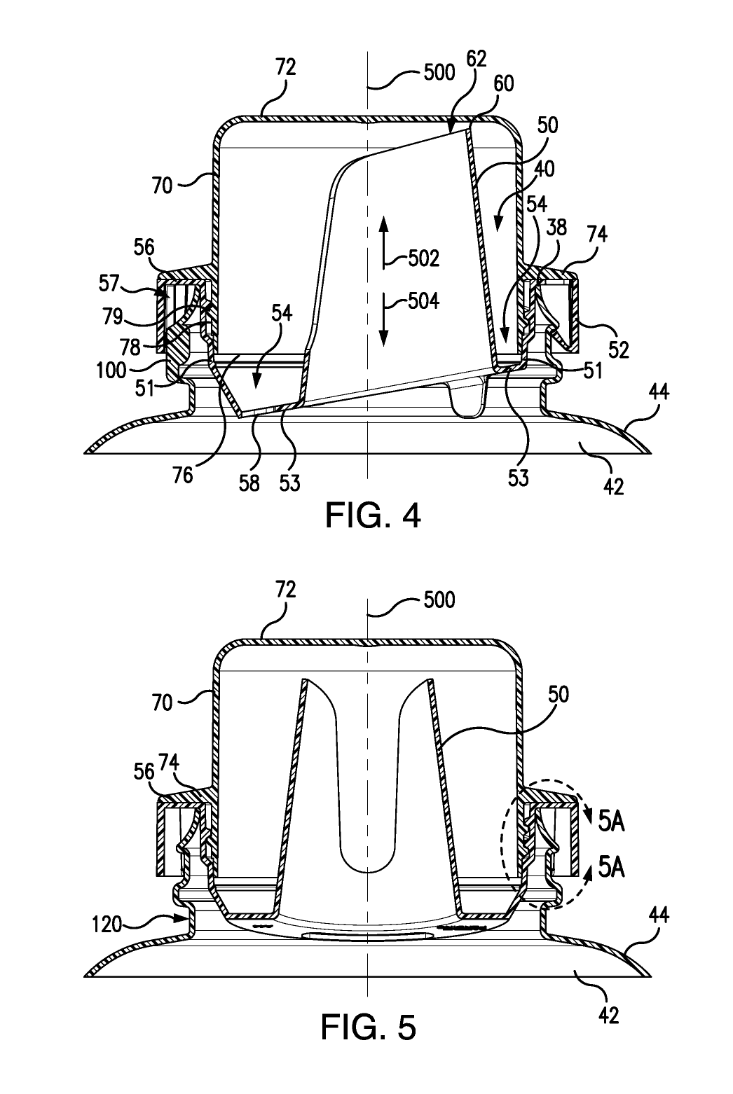

The body 22 comprises a unitary combination of a base 30, a sidewall 32 extending upward from the base, a shoulder 34 at an upper end of the sidewall, and a neck 36 extending upward from the shoulder to a rim 38 (FIG. 4) and defining an opening 40 having a central longitudinal axis 500. In this example, an axis 500 (FIG. 3) serves as a central longitudinal axis of the spout fitment, cap, and neck of the bottle. In this exemplary embodiment, the axis 500 is vertical when the bottle is resting atop a horizontal surface. Other orientations may be possible. With this exemplary frame of reference, the bottle in the upright condition, a direction 502 (FIG. 4) is upward parallel to the axis 500 and in opposite direction 504 is downward. Unless otherwise indicated, this frame of reference is used to explain relative position. Clearly, the bottle will be at least partially inverted to pour.

The bottle body has an interior surface 42 and an exterior surface 44. A handle 46 (FIG. 1) may extend from the sidewall and the body interior may extend through the handle

The spout fitment 24 includes an inner wall 50 (FIG. 4), an intermediate sidewall 51, and an outer sidewall 52. The intermediate sidewall and inner wall are joined by a lower wall 53 so as to define a trough 54. The intermediate sidewall and outer sidewall are joined by an annular web 56 to define a downwardly-open channel 57.

One or more drain-back apertures 58 (FIG. 4) are open to the trough 54 (e.g., through the wall 53). The inner wall 50 forms a spout and has an upper end 60 defining a spout opening 62. The upper end 60 peaks along a forward portion and dips along a rearward portion so that the opening 62 is asymmetric and defines a preferential direction for pouring.

The cap 26 includes a sidewall 70, a transverse web 72 at the upper end of the sidewall, and an outwardly projecting flange 74 spaced a short distance above a lower end (rim) 76 of the sidewall. An outer surface 78 (FIG. 4B) of the sidewall 70 bears an external thread 79.

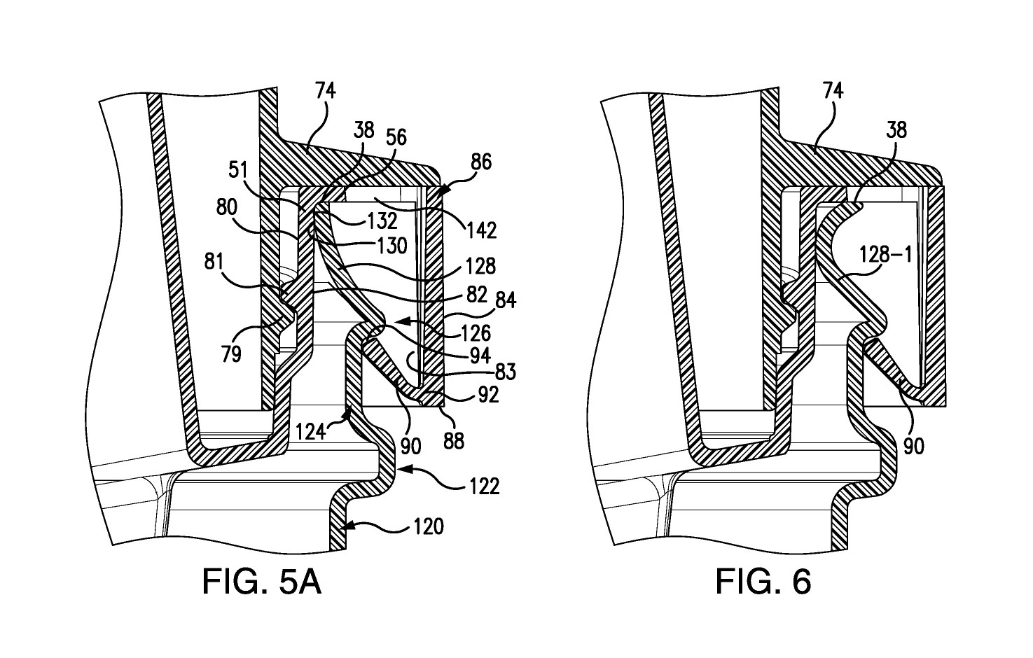

FIG. 5A shows the spout fitment intermediate sidewall 51 as having an inboard surface 80 bearing an internal thread 81. The intermediate sidewall 51 has an external/outboard surface 82. The outer sidewall 52 has an inboard surface 83, an outboard surface 84, upper end 86 (at a junction with the web 56) and a lower end or rim 88. A circumferential array of tabs 90 is formed along the outer sidewall extending upward. Each tab 90 has a proximal junction 92 with the remainder of the sidewall and an upper/distal end surface 94. As is discussed in further detail below, the surface 94 engages an adjacent surface of the bottle body to retain the spout fitment in an installed condition.

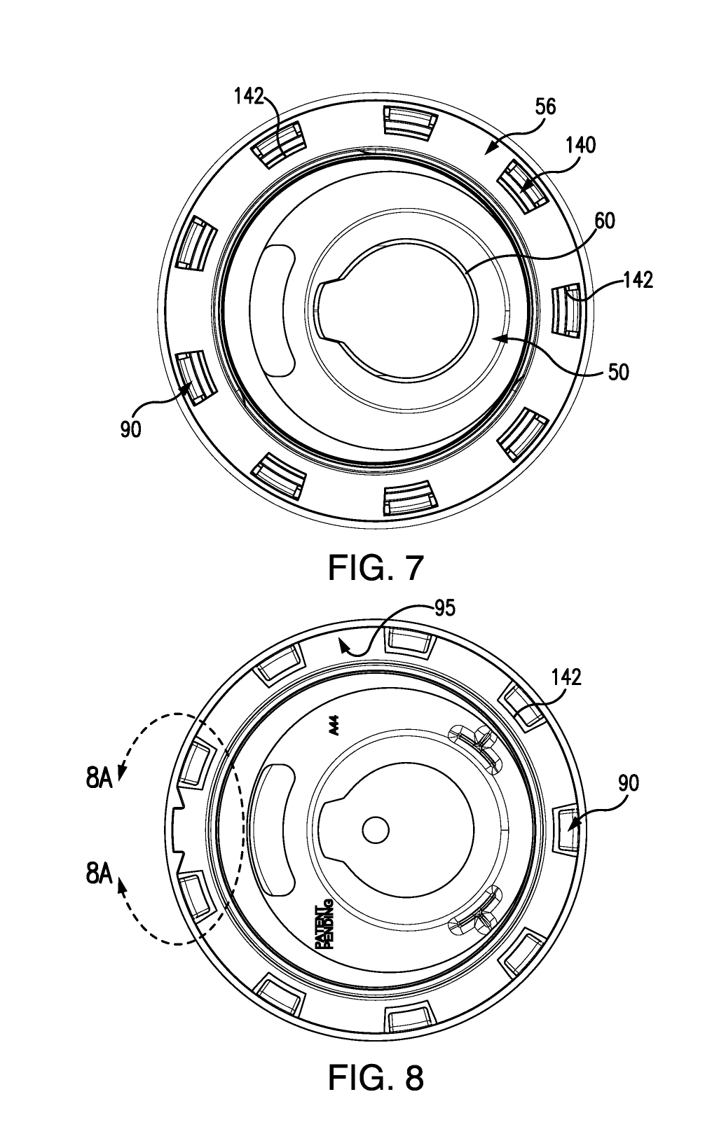

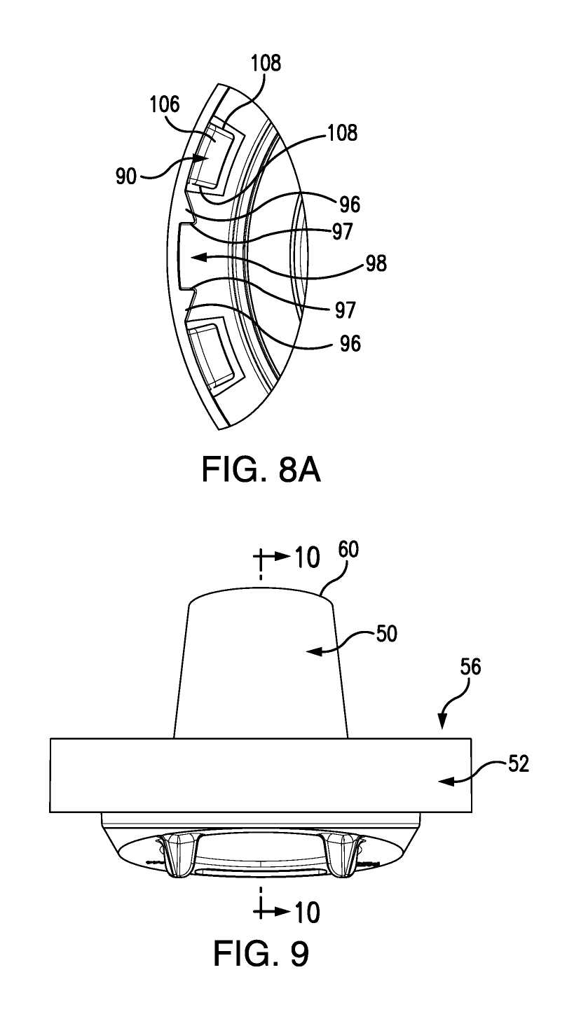

FIGS. 7 and 8 show an exemplary group of nine tabs 90. For this exemplary embodiment, an exemplary number of tabs is 5-36, more narrowly, 7-15. The exemplary tabs are of smaller circumferential span than the gaps 95 alternating in between.

In the exemplary embodiment, a pair of protrusions 96 extending radially inward from the outer wall form sidewalls of a channel 98 (FIG. 8A) between two of the tabs. The channel 98 receives a lug 100 (FIG. 4) of the bottle body neck. The circumferential sides of the lug 100 face corresponding circumferential ends 97 of the protrusions 96 so as to angularly orient the spout fitment within the bottle body so that the spout's preferential pour direction is always as desired relative to the bottle body (e.g., away from the handle).

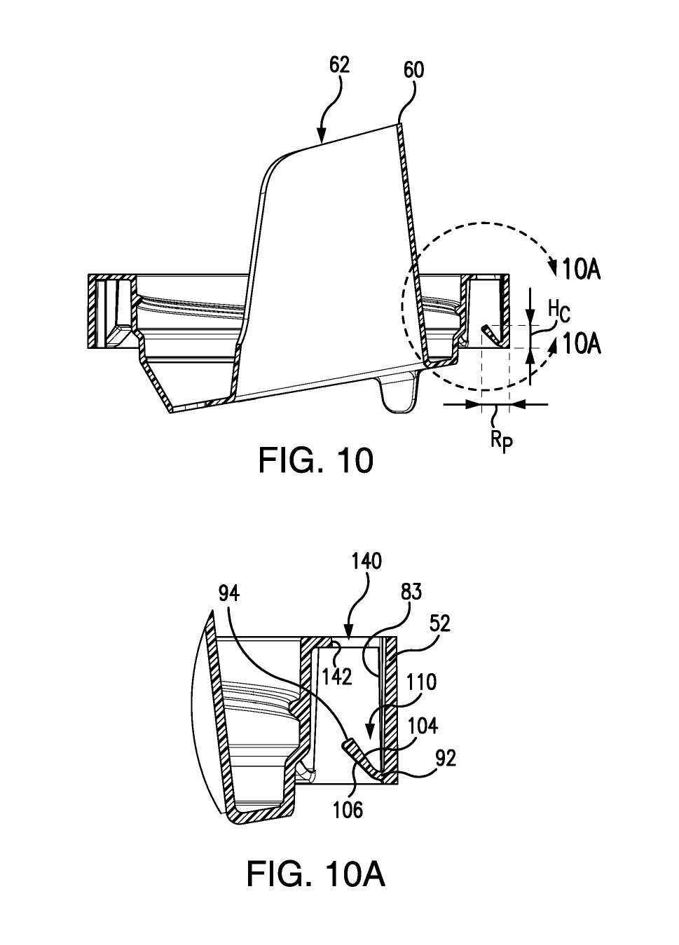

FIG. 10A shows opposite surfaces 104, 106 of the tabs 90 extending between the junction 92 and the distal end surface 94 with sides 108 (FIG. 8A) of the tabs joining the two. As is discussed further below, the tabs are shown protruding upward from the junctions 92 and in both as-molded and in-use conditions. The tabs define a partial channel 110 between the surface 104 and the inboard surface 83 of the outer sidewall 52.

An exemplary tab thickness increase between the junction 92 and the distal end surface 94 (or a location distal of the junction but not at the end) may be at least 30%, more particularly, at least 40% (e.g., 30% to 200% or 40% to 150% or 50% to 150%). An exemplary height of the tab (e.g., measured as a channel height He parallel to the axis) may be at least 1.5 mm (e.g., 2.0 mm to 10 mm or 2.5 mm to 5.0 mm). An exemplary thickness at the end 94 (or other peak thickness) is 0.05 inch (1.3 mm), more broadly 0.80 mm to 2.4 mm or 1.0 mm to 2.2 mm. Exemplary relaxed inward radial protrusion R_{P} is at least 2.0 mm (e.g., 2.0 mm to 10 mm or 2.5 mm to 6.0 mm).

Returning to FIGS. 5 and 5A, the neck has, from bottom-to-top, a lower generally tubular/cylindrical portion 120, a radially outwardly projecting flange 122 thereabove, and an intermediate portion 124 continuing upward from the flange 122. The flange 122 is a lower flange used for retaining the bottle during filling and capping as is known in the art. For example, during filling and capping, a fixture may receive the neck lower portion 120 with an upper face of the fixture supporting the underside of the flange 122. A second flange 126 is formed at an upper end of the intermediate portion 124.

FIG. 4 shows the exemplary lug 100 as being slightly radially proud of the upper flange 126 at the upper end of the intermediate portion 124 and also slightly radially proud of the outer diameter (OD) periphery of the lower flange 122. In cross-section (FIG. 5A), an arcuate upper portion 128 transitions upward from the flange 126 to the rim 38 and, along its interior, is vertically convex. This convexity helps provide a smooth transition on insertion of the fitment and provides close fitting abutting surfaces 130, 132 along the upper portion 128 and the intermediate wall outer surface 82, respectively. In the fully installed condition, the rim 38 is seated against the underside of the web or flange 56. In the fully installed condition, the distal end surfaces 94 of the tabs are contacting or in close-facing relation to an underside of the upper flange 126 so that attempted extraction of the fitment will be resisted by the backlocking engagement between the end surface 94 and the upper flange 126 underside.

In an exemplary method of manufacture, the tabs 90 and webs 92 are initially molded extending up from the fitment outer/outboard sidewall 52. This is a departure from the aforementioned PCT/US15/25892 (wherein the as-molded condition is downward and the tabs are partially inverted prior to spout fitment insertion).

Molding projections extending radially inward from the surface 83 presents difficulties whether these projections are finger-like tabs as shown or are more barb-like (i.e. lacking the partial recess 110 of FIG. 10A). To mold upper portions of the projections (e.g. the surface 104 of the exemplary tabs 90 and at least a portion of the exemplary end surface 94) tooling must have access from above. The methods of manufacture and the tooling leaves the resulting spout fitment with telltale apertures 140 defined by perimeter surfaces 142 (FIG. 10A and FIG. 7).

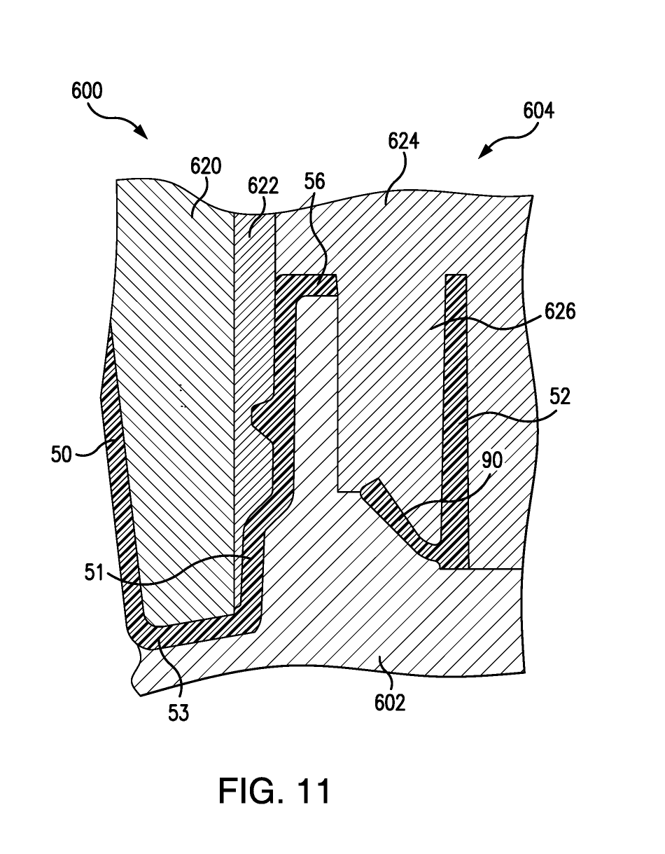

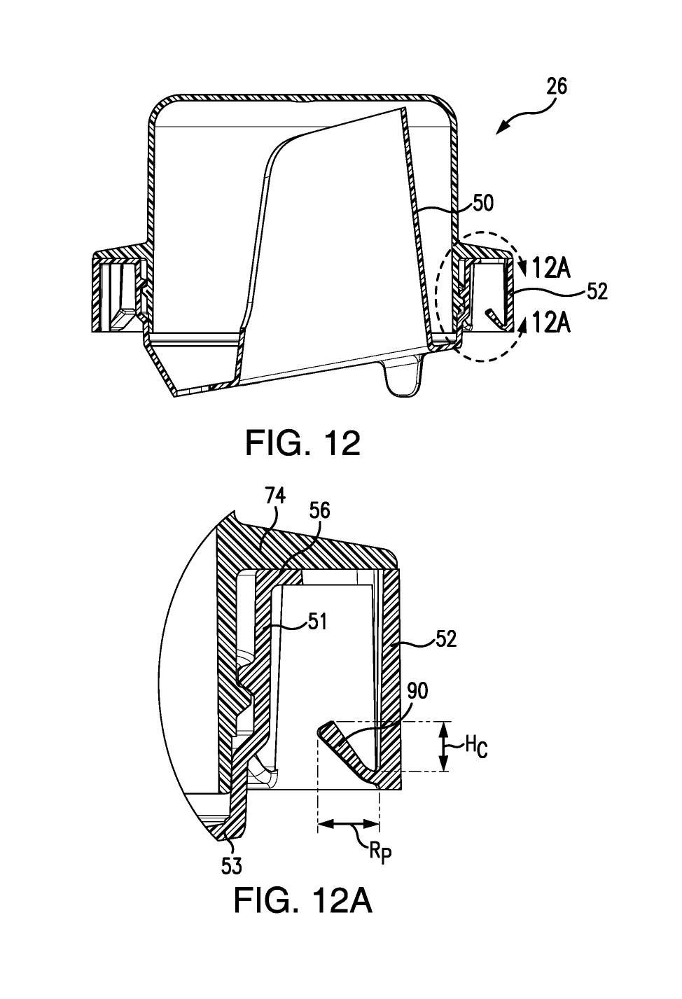

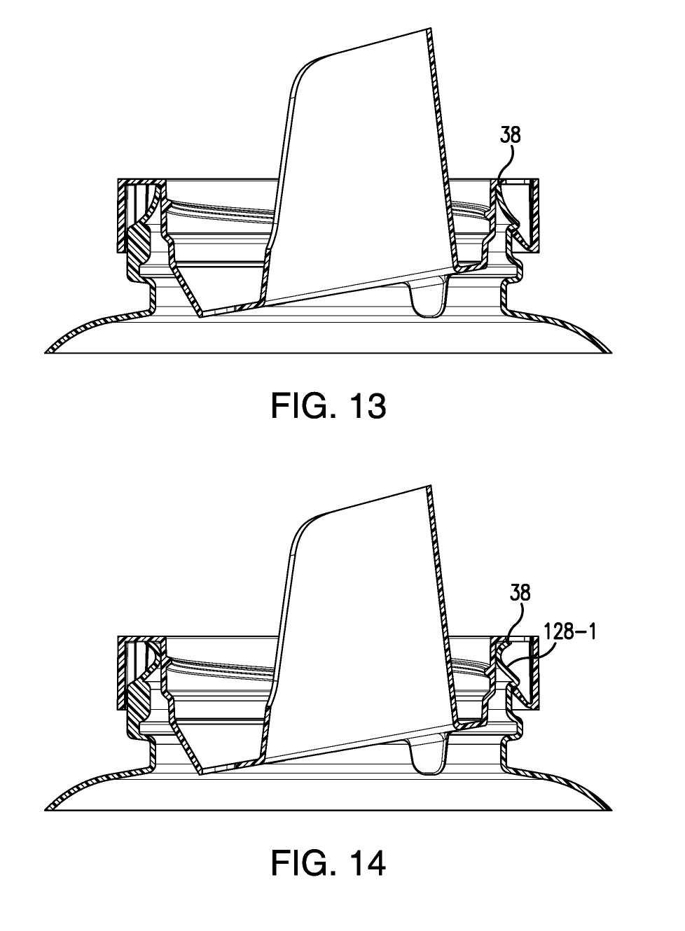

FIG. 11 shows a mold 600 having a lower portion 602 and an upper portion 604. Each of these mold portions may be itself a subassembly of multiple portions or pieces. While the upper and lower portions may respectively retract away from each other to release the part, each of the mold portions may itself be a subassembly of portions or pieces that are fixed or movable relative to each other. For example, FIG. 11 shows the upper portion as including an inner core 620 for molding portions of the spout and the upper surface of the lower wall 53. After molding this may be removed/disengaged via extraction. However, outboard thereof a thread core 622 molds the spout fitment internal thread and may be removed via a combined rotation and extraction in an unscrewing action. Outboard of the core 622 may be a core 624 that includes the aforementioned projections or fingers 626. In this exemplary embodiment, an upper portion of the core 624 molds the upper surface of the flange 56 and the outboard surface of the outer side wall 52.

The exemplary projections 626 have portions that mold the surfaces 104 and 94. Once molded, the projections 626 retract upwardly out of the apertures 140 (this may involve movement of the core portion or a pneumatic or other ejection of the molded spout fitment).

For sealing, it is seen in FIG. 5A that the exemplary contact between the bottle neck along the rim 138 and surface 130 is inboard of the inboard portion of the perimeter surface 142. Additionally, the cap flange 74 closes/covers the apertures in its installed condition.

FIGS. 6 and 14, however, show an alternate bottle neck configuration wherein, adjacent the rim 38, the neck upper portion 128-1 flares radially outward. This may provide a greater spring compliance.

In an exemplary method of assembly, the cap is fully or partially screwed onto the spout fitment. The spout fitment is then inserted into the bottle neck. During insertion engagement of inboard surfaces 106 of the tabs 90 with the bottle outboard surface along the neck flexes the tabs outward (e.g., compressing the channel between the tab and the outboard sidewall 52 and/or flexing the outboard sidewall 52).

Eventually, the tabs 90 pass over the flange 126 and relax into the locking engagement described above. Dimensions may be such that interference contact between the surfaces 130 and 132 provides a sealing under normal loads associated with pouring.

In one exemplary installation operation, the cap is fully or partially screwed on to the spout fitment prior to insertion of the spout fitment. If the bottle was not filled prior to insertion, the cap may thereafter be unscrewed and removed so that the bottle may then be filled. The cap may be further tightened (screwed back on) if needed.

Various implementations may have one or more of various advantages. One group of advantages relate to elimination of welding or adhering of the spout fitment to the bottle body. In addition to the economy of a saved step, this may facilitate delivery of the liquid before attaching the spout fitment to the bottle body which may allow more efficient processing (e.g., including higher flow delivery or less precisely aimed delivery through an opening in the bottle body larger than the spout opening). The spout fitments and caps may be delivered to the bottler as units and installed in units, thereby easing installation. Other potential advantages include weight reduction and reduced intrusion of the spout fitment into the bottle body (thereby permitting higher fill levels). Other potential advantages include improved sealing. Finally, there may be greater flexibility in aesthetics by permitting relatively easy use of differently-styled spout fitments with a given bottle body or differently styled bottle bodies with a given spout fitment. Relative to the aforementioned PCT/US15/25892, the step of tab inverting may be avoided. This may reduce machine count in the factory and may reduce opportunity for defects and machine failure.

The use of “first”, “second”, and the like in the description and following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

Where a measure is given in English units followed by a parenthetical containing SI or other units, the parenthetical's units are a conversion and should not imply a degree of precision not found in the English units.

One or more embodiments of the present invention have been described. Nevertheless, it will be understood that various modifications may be made without departing from the spirit and scope of the invention. For example, when implemented in the reengineering of an existing container configuration, details of the existing configuration may influence or dictate details of any particular implementation. Accordingly, other embodiments are within the scope of the following claims.

What is claimed is:

1. A spout fitment having:
a spout;
an outer wall;
an intermediate wall between the outer wall and the spout;
a plurality of projections extending from the outer wall; and
a plurality of apertures each aligned with a respective associated projection of the plurality of projections.

2. The spout fitment of claim 1 further comprising:
a flange joining the outer wall to the intermediate wall, the plurality of apertures extending through the flange.

3. The spout fitment of claim 1 wherein:
there are seven to fifteen said apertures and an equal number of said projections.

4. A container comprising:
a body having a neck extending to a mouth defining a body opening;
said spout fitment of claim 1 having:
said spout within the body opening; and
said outer wall surrounding an upper portion of the neck; and
said plurality of projections in backlocked engagement with one or more features of the neck; and
a cap having sidewall, an external thread of the cap sidewall engaged to an internal thread of the intermediate wall.

5. The container of claim 4 wherein:
the plurality of projections extend mouthward from the outer wall.

6. The container of claim 4 wherein:
a channel along an inner surface of the outer wall receives a lug of the body to angularly register the spout fitment.

7. The container of claim 4 wherein:
the one or more features is a single full annulus feature.

8. The container of claim 4 wherein:
the one or more features is a protrusion from an outer surface of the neck having an associated recess in an inner surface of the neck.

9. The container of claim 4 wherein:
the one or more projections have a proximally tapering thickness from a distal end to a root end.

10. The container of claim 4 wherein:
the one or more projections are a plurality of projections in a circumferential array.

11. The container of claim 4 wherein:
the fitment is neither adhered nor welded to the body.

12. The container of claim 4 wherein:
the fitment is not threadingly engaged to the body.

13. The container of claim 4 wherein:
a cap sealing surface is along an underside of a flange of the cap.

14. The container of claim 4 wherein:
the cap sealing surface covers the apertures.

15. A method for molding the spout fitment of claim 1, the method comprising:
injecting plastic into a mold having a first portion and a second portion, the mold first portion molding an upper portion of the respective projections and the mold second portion molding lower portions of the respective projections; and
separating the mold first portion from the mold second portion, the first portion comprising a plurality of fingers that withdraw through the respective apertures.

16. A method for using the spout fitment of claim 1, the method comprising:
inserting the spout fitment into a neck portion of a container body, the inserting comprising a resilient deformation of the at least one projection followed by an at least partial relaxation so as to engage a locking surface of the at least one projection to a locking surface of the container body to resist a reverse extraction; and
threading a cap onto at least one of the spout fitment and container body.

17. The method of claim 16 wherein:
the threading is at least partially before the inserting.

18. The method of claim 16 wherein:
the inserting consists essentially of a linear insertion.

19. The method of claim 15 further comprising:
delivering at least 1.0 liter of a liquid into the container body.
